(19) United States
(12) Patent Application Publication
(10) Pub. No.: US 2007/0171594 A1
(43) Pub. Date: Jul. 26, 2007

(54) High density capacitor for integrated circuit technologies

(76) Inventors: Mark M. Budnik, Valparaiso, IN (US); Arijit Raychowdhury, West Lafayette, IN (US); Aditya Bansal, West Lafayette, IN (US); Kaushik Roy, West Lafayette, IN (US)

Correspondence Address: BAKER & DANIELS LLP, 300 NORTH MERIDIAN STREET, SUITE 2700, INDIANAPOLIS, IN, 46204, US

(21) Appl. No.: 11/640,691

(22) Filed: Dec. 18, 2006

Related U.S. Application Data
(60) Provisional application No. 60/751,270, filed on Dec. 16, 2005.

(51) Int. Cl. H01G 4/06

(52) U.S. Cl. 361/321.1

(57) ABSTRACT

An apparatus and method are provided of forming a capacitor including carbon nanotubes.

### CROSS REFERENCE TO RELATED APPLICATION

This application claims the benefit of U.S. Provisional Application Ser. No. 60/751,270, filed on Dec. 16, 2005, which is expressly incorporated by reference herein.

### BACKGROUND AND SUMMARY OF THE INVENTION

The present application relates to the use of carbon nanotube devices for implementing a high density, three dimensional capacitor structure useful for analog and RF applications and supply voltage variation decoupling. The capacitor structure illustratively includes staggered layers of interleaved carbon nanotubes which are alternately connected to anode and cathode contacts. The illustrated device can realize a capacitance per unit area that is significantly larger than the International Technology Roadmap for Semiconductors's projected requirements for year 2018. The capacitance per unit area can exceed 1 pF/μm², with a quality factor greater than 100 at 1 GHz.

According to an illustrated embodiment, a method of forming a capacitor includes providing an anode and a cathode; providing an array of carbon nanotubes (CNTs) generally arranged in a plurality of rows and columns; selectively connecting the CNTs in the array to the cathode and the anode; and providing a dielectric material between the CNTs.

According to another illustrated embodiment, a high density capacitor includes an anode; a cathode; an array of carbon nanotubes (CNTs) generally arranged in a plurality of rows and columns, the CNTs being selectively coupled to the cathode and the anode; and a dielectric material located between the CNTs.

In one illustrated embodiment, the array includes staggered layers of interleaved CNTs which are alternately connected to the anode and the cathode so that each CNT in the array is surrounded by four CNTs connected to an opposing electrode. In other words, each CNT connected to the anode is surrounded by four adjacent CNTs connected to the cathode and each CNT connected to the cathode is surrounded by four adjacent CNTs connected to the anode.

In illustrated embodiments, the capacitor may be used as a replacement for metal-insulator-metal (MIM) capacitor, as a supply voltage variation decoupling circuit, or as an add-on module in a top layer of a silicon wafer manufacturing process.

Features of the invention will become apparent to those skilled in the art upon consideration of the following detailed description of the presently perceived best mode of carrying out the invention.

### BRIEF DESCRIPTION OF THE DRAWINGS

The detailed description particularly refers to the accompanying figures in which:

FIG. 1(a) illustrates a high density capacitor composed of interleaved carbon nanotube cathodes (C) and anodes (A).

FIG. 1(b) is an electrical representation of carbon nanotube capacitor structure.

FIG. 2(a) is an illustrative geometry of two parallel carbon nanotubes.

FIG. 2(b) is an electrical model of the parallel carbon nanotube system.

FIG. 3. is a graph illustrating the resistance of an individual carbon nanotube resistance vs. length (l) and applied bias voltage.

FIG. 4. illustrates a subset of the carbon nanotube structure with an individual electrostatic coupling capacitor (C_{C}).

FIG. 5 is a graph illustrating the density of states of a metallic carbon nanotube in which the singularity occurs at approximately ±1.3V.

FIG. 6 is a graph illustrating the quantum capacitance of a carbon nanotube conduction mode as a function of the applied bias voltage.

FIG. 7 illustrates a distributed model of parallel carbon nanotube system showing the average parasitic resistance and inductance values are R+ΔR and L+ΔL, respectively.

FIG. 8 illustrates an electrical model of the capacitor structure for each carbon nanotube interconnect cathode.

FIG. 9 illustrates a three series element model of the capacitor structure for each carbon nanotube cathode.

FIG. 10 is a graph illustrating the carbon nanotube capacitor's equivalent series resistance (R′) and inductance (L′) vs. nanotube length (l) and number of nanotubes (N) with a 1V applied bias.

FIG. 11 is a graph illustrating the carbon nanotube interconnect capacitor's quality factor (Q) vs. frequency and nanotube spacing (s).

### DETAILED DESCRIPTION OF DRAWINGS

The complete disclosures of the following listed references are expressly incorporated herein by reference:

[1] B. Razavi, Design of Analog CMOS Integrated Circuits, New York: McGraw-Hill, 2001.

[2] International Technology Roadmap for Semiconductors. [Online]. Available: http://public.itrs.net/.

[3] M. S. Dresselhaus, G. Dresselhaus, and P. Avouris, Carbon Nanotubes: Synthesis, Structure, Properties and Applications. New York: Springer-Verlag, 2001.

[4] B. Q. Wei, R. Vajtai, and P. M. Ajayan, “Reliability and current carrying capacity of carbon nanotubes,” Appl. Phys. Lett., vol. 79, Aug. 2001, pp. 1172-1174.

[5] L. Zhu, Y. Sun, J. Xu, Z. Zhang, D. W. Hess, C. P. Wong, “Aligned carbon nanotubes for electrical interconnect and thermal management,” Proc. Electronic Components and Technology, vol. 1, pp. 44-50, June, 2005.

[6] M. Nihei, et al., “Low-resistance multi-walled carbon nanotube vias with parallel channel conduction of inner shells,” Proc. Interconnect Technology Conference, pp. 234-236, June, 20.

[7] A. Raychowdury and K. Roy, “A circuit model for carbon nanotube interconnects: Comparative study with Cu interconnects for scaled technologies,” in Proc. Int. Conf Computer Aided Design, 2004, pp. 237-240.

[8] P. L. McEuen, M. S. Fuhrer, and H. Park, “Single-Walled Carbon Nanotube Electronics,” IEEE Trans. Nano., vol. 1, no. 1, Mar. 2002, pp.78-85.

[9] S. Salahuddin, M. Lundstrom, and S. Datta, “Transport Effects on Signal Propagation in Quantum Wires,” TED, in press, 2005.

[10] J. Y. Park, et al., “Electron-phonon scattering in metallic single-walled carbon nanotubes,” Nano Lett., vol. 4, no. 3, pp. 517-520, 2004.

[11] P. J. Burke, “Luttinger liquid theory as a model of the gigahertz electrical properties of carbon nanotubes,” IEEE Trans. Nanotech., vol. 1, no. 3, pp. 129-144, Sep. 2002.

[12] J. W. Mintmire and C. T. White, “Universal Density of States of Carbon Nanotubes”, PRL, vol. 81, No. 12, 1998, pp: 2506-2509.

[13] AVX [Online]. Available: http://www.avx.com/.

These references are referred to in this application by citations to the particular reference numbers [1] to [13] listed above.

Capacitors are important components in nanoscale processor circuits [1]. They are used in a variety of applications including the suppression of supply voltage variation (decoupling circuits) and analog/radio frequency signal processing (i.e. switched capacitor circuits). Today's semiconductor capacitors are based upon a parallel plate topology with different electrode materials (poly-diffusion, poly-poly, metal-poly, metal-insulator-metal, and metal-oxide-semiconductor). Their capacitance, however, is still governed by their parallel plate area (A), their dielectric thickness (t_{Dielectric}) and the permittivity of the intervening dielectric (∈_{Dielectric}):

$$C = \frac{{ε}_{Dielectric} A}{{t}_{Dielectric}} \qquad ( 1 )$$

Because of their parallel plate capacitor topology, however, today's semiconductor capacitors face numerous challenges in the near future [2]. First, as component dimensions are scaled, decreasing parallel plate capacitor area will result in a marked reduction in capacitance. Reducing t_{dielectric} will offset the decreasing capacitance, but can lead to higher levels of leakage current. Finally, while new dielectric materials are being explored, their manufacturability is yet to be determined [2]. Therefore, new semiconductor capacitor candidate materials and topologies are being investigated for future nanotechnology generations.

Carbon nanotubes (CNTs) are cylinders of very small diameter formed by rolling sheets of graphite [3]. When rolled correctly, a CNT can exhibit metallic properties, without a distinct bandgap. As such, these metallic CNTs have long been proposed as a possible interconnect material for future generations of nanoscale technologies, replacing existing aluminum and copper inter-connects [3]. When CNTs are rolled with a single wall, ballistic transport of the electrons is possible in the presence of small and moderate electric fields. In addition, the current density of CNTs has been shown not to degrade even under extreme operating conditions (350 hours for J≈10¹⁰A/cm2 at 250 C [4]). Finally, the mechanical properties of CNTs have been shown as superior to metals traditionally used in semiconductor devices. For all these reasons, CNTs are viewed as possible candidates to replace traditional aluminum and copper interconnects in future generations of semiconductor devices.

Much research has been undertaken into the manufacturability of CNTs. Aligned CNTs have been grown using chemical vapor deposition [5], and low resistance CNT vias have been reported [6]. While additional work is still required to facilitate multi-direction growth and improved CNT-contact resistance, CNTs are still viewed as potential candidates for traditional metallic interconnects.

The properties that can make CNTs excellent interconnects can also be used to create a very high density capacitor structure. The illustrated CNTs are arranged in an organized array for use in an integrated circuit. The CNTs in the array are selectively connected to a cathode and an anode of the capacitor. A dielectric material is provided between the CNTs.

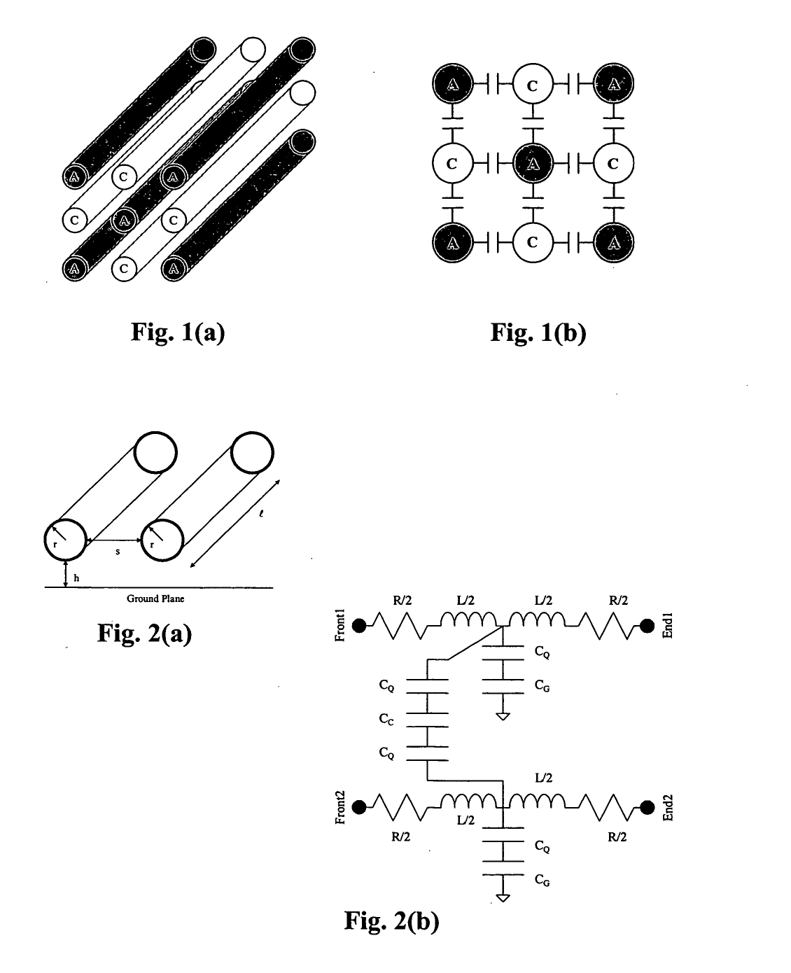

An illustrated capacitor, CNCAP (Carbon Nanotube CAPacitor), comprises multiple layers of interleaved CNTs which are alternately connected to the cathode and anode. Each CNT electrode is illustratively surrounded by four CNTs connected to the opposing electrodes as shown in FIGS. 1(a) and (b). It is understood that the CNTs may be connected in alternative patterns to the cathode and anode in other embodiments of the present invention.

In one embodiment, the anode and cathode are located at opposite ends of the CNTs and are coupled to end portions of selected CNTs in the pattern shown in FIGS. 1(a) and 1(b). In another embodiment, the CNTs may be coupled to the anode or cathode by suitable connections to the CNTs which are spaced apart from the ends of the CNTs.

The illustrated CNCAP may provide a very high capacitance/area in excess of 1 pF/μm². This is two orders of magnitude greater than the Technology Roadmap for Semi-conductors (ITRS) projected capability (10 fFμm²) of metal-insulator-metal (MIM) capacitor devices in the year 2018 [2]. CNCAP's quality factor is sufficient for use in analog and radio frequency applications. It can be used as a general replacement for MIM capacitors. CNCAP's large capacitance per unit area makes it an excellent candidate for supply voltage variation decoupling circuits. Finally, the unique CNT structure of the CNCAP permits it to be fabricated as an add-on module in the top layers of traditional silicon manufacturing processes.

The present application discloses an illustrative structure and model of CNCAP. In Section 2, the geometry and electrical model of individual cathode and anode CNT pairs is illustrated. In Section 3, the electrical model for the entire CNCAP structure is illustrated. Finally, a comparison of the CNCAP structure to existing MIM capacitors is illustrated in Section 4.

2. Carbon Nanotube Capacitor Unit Cell

FIG. 2(a) shows two parallel CNTs. The physical parameters are: r (radius of the CNTs), s (spacing between the CNTs), l (length of the parallel CNTs), and h (the height of the CNTs above a ground plane). An electrical model of the two parallel CNTs [7] is shown in FIG. 2(b). In Section 2.1, the resistance of the CNTs is presented. The inductance of the CNTs is presented in Section 2.2. Various capacitance components of the CNT cathode-anode CNT pair are presented in Section 2.3.

2.1 Carbon Nanotube Resistance

One of the hallmarks of one-dimension conduction is the limiting quantum resistance. This one-dimensional conduction is characteristic of CNTs. As such, Ohm's Law does not hold for CNTs [8]. When the length of the conductor is scaled to the lengths less than the mean free path of scattering of electrons, a regime of ballistic transport is entered. Because of their ability to achieve ballistic transport, CNTs are considered possible candidates to replace short and long metallic interconnects in future technologies. However, the current flowing through the CNTs even in the limit of ballistic transport is limited by the fundamental resistance of one-dimensional transport, namely, the quantum contact resistance.

Because of their band structure, CNTs have two modes of propagation. In addition, in each of the two modes, the electrons can be either spin up or spin down resulting in four channels of conduction. When the CNT is modeled as a one dimensional conductor, these channels can be considered as four separate, but parallel, non-interacting channels of transport. For each channel of transport, the quantum contact resistance has a value of h/e² [8]. Therefore, the quantum contact resistance for a CNT is:

$${R}_{Q , CONTACT} = \frac{1}{4} ( \frac{h}{{e}^{2}} ) . \qquad ( 2 )$$

However, when the channel length of a one-dimension conductor is increased beyond the mean free path of scattering of electrons, its resistance will increase. Below a critical bias threshold, the principle scattering mechanism in a CNT is due to acoustic phonons. From [9], [10], the resistance of a single CNT (under low bias conditions) is given by:

$$\begin{matrix}R = {R}_{Q , CONTACT} + \frac{1}{4} ( \frac{h}{{e}^{2}} ) ( \frac{l}{{λ}_{acc}} ) & ( 3 ) \\ R = \frac{1}{4} ( \frac{h}{{e}^{2}} ) ( 1 + \frac{l}{{λ}_{acc}} ) & ( 4 )\end{matrix}$$

where l is the length of the CNT and λ_{acc} (approximately 1.6 μm) is the mean free path due to acoustic phonon scattering.

For higher biases, other scattering mechanisms (optical phonon and zone boundary phonon) may occur, and the CNT resistance may increase appreciably. Therefore, the CNT resistance is not only a function of its length, but also its bias voltage. The resistance of the same CNT under high bias conditions is given by:

$$R = \frac{1}{4} ( \frac{h}{{e}^{2}} ) [ 1 + l ( \frac{1}{{λ}_{acc}} + \frac{1}{0.16 l / V + {λ}_{high field}} ) ] . \qquad ( 5 )$$

where λ_{high field} (approximately 30 nm) is the mean free path at high electric fields, and V is applied bias.

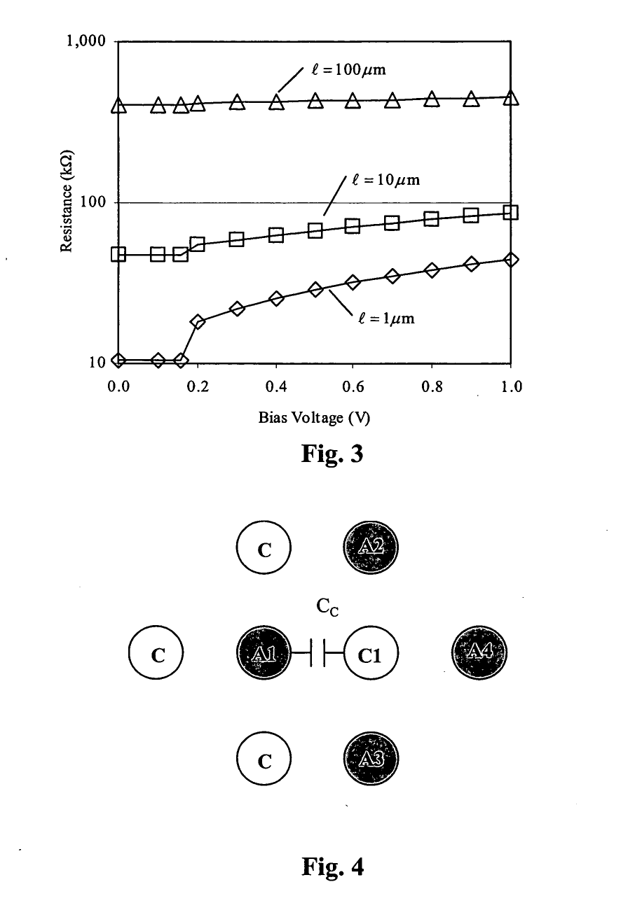

The CNT resistance vs. l and V for high bias conditions are shown in FIG. 3. The resistance is a strong function of the nanotube length. The voltage dependency is moderate for short nanotubes, and relatively weak for tubes in excess of 10 μm.

2.2 Carbon Nanotube Inductance

To effectively model the CNT inductance, both the magnetic inductance and the kinetic inductance is considered.

The magnetic inductance per unit length is given by [11]:

$${L}_{MAGNETIC} = \frac{μ}{2 π} {cosh}^{- 1} ( \frac{h}{r} ) . \qquad ( 6 )$$

Using typical values, the magnetic inductance is approximately 1 pH/μm [11]. From [11], the kinetic inductance per unit length for each of the four parallel but non-interacting modes of conduction in a CNT is given by:

$${L}_{KINETIC / Mode} = \frac{h}{2 {e}^{2} {v}_{F}} \qquad ( 7 )$$

where ν_{F} is the Fermi velocity in graphite (approximately 7.96×10⁵m/s). From (4), the kinetic inductance for each mode is 16.3 nH/μm. Because L_{KINETIC/Channel} is several orders of magnitude larger than its magnetic counterpart, L_{MAGNETIC} is usually neglected. Therefore, the net inductance (L) of the four parallel channels of conduction is given by L_{KINETIC/Mode}/4 (4.07 nH/μm).
2.3 Carbon Nanotube Capacitance

In this section, the three different capacitances inherent in parallel CNTs are addressed: ground capacitance, quantum capacitance, and coupling capacitance. An analysis of the linearity of the capacitance vs. applied bias is also provided.

2.3.1 Ground Capacitance

Recall the staggered, interleaved CNT interconnect structure shown in FIG. 1. To a first order, only the CNTs on the top and the bottom of the structure will contribute to the ground capacitance (C_{G}). It is assumed a distance from the ground plane sufficient to let C_{G} be negligible in the analysis of CNCAP.

2.3.2 Quantum Capacitance

Next, the quantum capacitance (C_{Q}) is discussed. From [11], the electrons in a CNT can be thought of as a quantum electron gas in one dimension. Following Pauli's exclusion principle, it is not possible to add an electron with energy less than the Fermi energy of the system. For a CNT, the energy required to add an extra electron is given by:

$$δ = \frac{h {v}_{F}}{l} \qquad ( 8 )$$

Equating βwith the energy stored in the quantum capacitance:

$${C}_{QUANTUM / Channel} = \frac{2 {e}^{2}}{h {v}_{F}} \qquad ( 9 )$$

Recalling ν_{F} is the Fermi velocity in graphite, the quantum capacitance for each channel is 97.0 aF/μm. However, C_{QUANTUM/Channel} of the four modes of conduction are in parallel. Therefore, the net quantum capacitance (C_{Q}) for each of the parallel CNTs in FIG. 2 is 388 aF/μm.

2.3.3 Coupling Capacitance

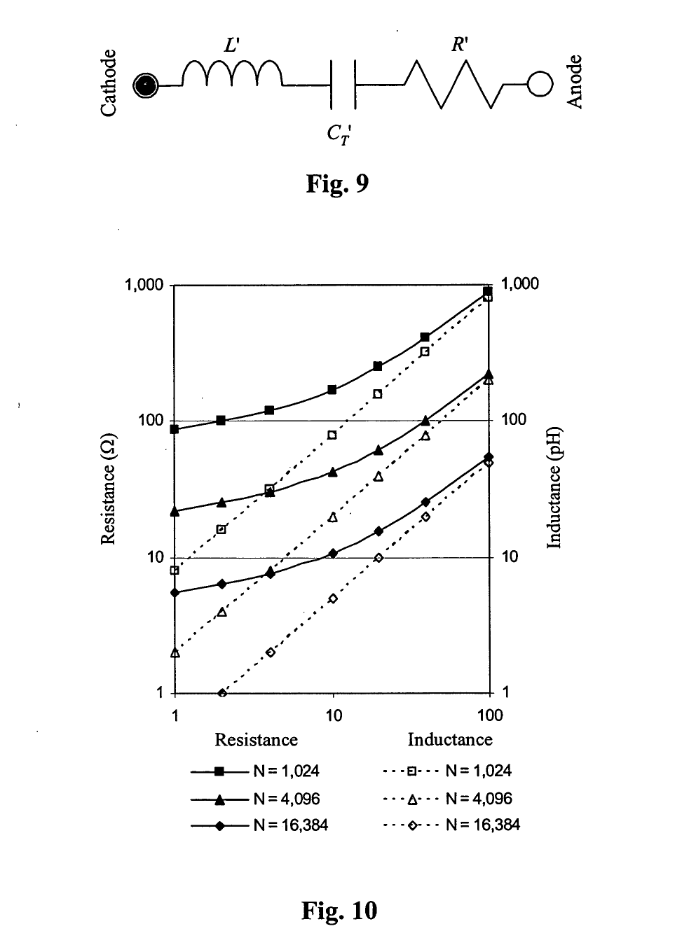

The coupling (electrostatic) capacitances between neighboring CNT cathodes and anodes in the CNCAP was determined. Silicon dioxide was assumed for the dielectric. The Laplace equation is numerically solved for the subset interconnect structure (FIG. 9) in the metallic limit (conductivity →∞), neglecting the fringing field at the ends of CNTs (a valid assumption for l >>s).

It is assumed that all of the electric field emanating from cathode C1 terminates on the four “nearest neighbor” anodes (A1-A4). In addition, these electric field lines are equally distributed between A1-A4. Therefore, the structure in FIG. 9 gives an accurate estimate of the capacitance (C_{C}) between the CNTs C1 and A1 in the CNCAP structure. It is assumed that r=0.5 nm. For s=2.0, 2.5, 3.0, and 4.0 nm; C_{C} is 22.8, 19.9, 18.1, and 15.6 aF/μm, respectively.

2.3.4 Total Capacitance vs. Applied Bias

For high performance designs, especially in the analog and RF domains, the linearity of the on-chip capacitor is an important prerequisite. A non-linearity in the capacitor can lead to harmonic distortion and reduce signal quality and fidelity. Consequently, it is useful to determine the linearity of the illustrated capacitor structure. It has already been observed that the total capacitance (C_{T}) between a cathode CNT and an anode CNT is a series combination of C_{Q} and C_{C}.

$${C}_{T} = {[ \frac{1}{{C}_{Q}} + \frac{1}{{C}_{C}} + \frac{1}{{C}_{Q}} ]}^{- 1} \qquad ( 10 )$$

C_{C} is a function of the geometry, and therefore, is independent of the applied bias. For C_{Q}, however, a detailed analysis is required.

When a voltage is applied to a CNT, the Fermi level shifts rigidly, and additional states are populated. For a metallic CNT, the bandgap is zero (neglecting curvature effects) and the E-k diagram is linear for the first mode of conduction. This corresponds to a constant metallic density-of states given by [12]:

$${D}_{O} = \frac{8}{3 π {a}_{cc} t} \qquad ( 11 )$$

where a_{cc} is the carbon-carbon bond length (˜0.142 nm) and t is the tight binding carbon-carbon bond energy (˜3 eV).

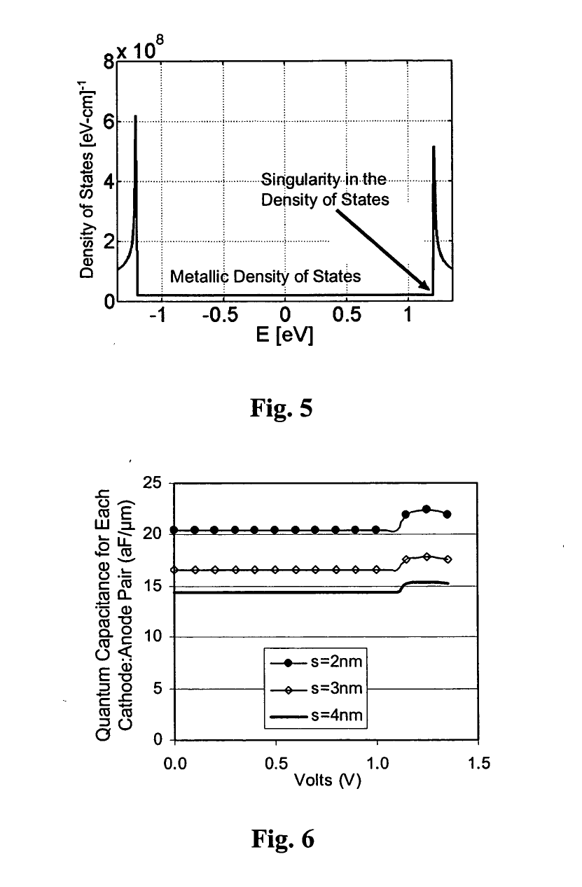

As the Fermi level shifts higher, the second energy band starts to populate. The density of states corresponding to this energy band is characterized by the Van Hoff singularity, a hallmark of one dimensional conduction. The singularity occurs at the band edge, E_{G}, and the total density of states appears as shown in FIG. 5. It is given by [9]:

$$D ( E ) = \frac{2 {D}_{O} E}{\sqrt{{E}^{2} - {E}_{G}^{2}}} \qquad ( 12 )$$

The i^{th} band-edge occurs at:

$${E}_{G} ( i ) = \frac{3 {a}_{cc} t ( i - 1 )}{2 r} \qquad ( 13 )$$

where, r is again the radius of the nanotube. The quantum capacitance per conduction channel is given by [9]:

$${C}_{QUANTUM / Channel} = - {e}^{2} \frac{\partial n}{\partial E} \qquad ( 14 )$$

where the total number of carriers is n.

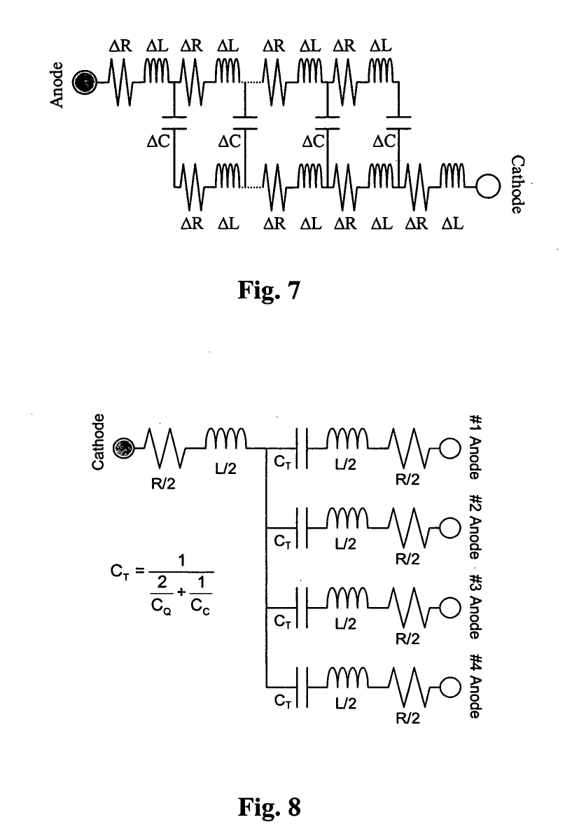

C_{QUANTUM/Channel} can be evaluated using (7)-(10). It is plotted against different bias voltages in FIG. 7. Until the first singularity is reached, it is independent of the bias voltage. For a nanotube of radius of 0.5 nm, this occurs approximately at 1.3V. Hence, for operating voltages below 1.3V, C_{Q} (and hence C_{T}) is independent of the applied bias voltage. Consequently, the illustrated CNCAP provides high linearity. Recall, C_{Q}=388 aF/μm. For s=2.0, 3.0, and 4.0 nm; C_{T} is 20.4, 16.6, and 14.4 aF/μm, respectively. C_{T} vs. applied bias is shown in FIG. 6.

3. Illustrated Capacitor Model

With the resistance, inductance, and capacitance characteristics determined, the electrical model of the illustrated CNCAP structure is then developed. It comprises multiple layers of interleaved CNTs, alternately connected to the cathode and anode FIGS. 1(a) and 1(b). Each CNT is surrounded by four CNTs connected to the opposing electrode. This provides a very high ratio of electrode surface area to volume spacing and a very high capacitance/area device.

Assuming the staggered, interleaved CNT inter-connect structure is uniform, the coupling capacitance between each of the interior nanotubes is assumed to be equal. The capacitive coupling between fringe nanotubes will be larger than the coupling between interior nanotubes. To the first order, the capacitances can be assumed to be equal. The magnitude of the coupling capacitance is addressed in the next sub-section.

Next, it is assumed that a distributed model applies for any two opposing electrode CNTs (FIG. 7). Therefore, the average equivalent series resistance for the capacitor is R+ΔR. The average equivalent series inductance for the capacitor is L+ΔL. As ΔR and ΔL go to zero, the series resistance and series inductance for any cathode-anode CNT pair will be given by R and L, respectively.

Using the above information, an electrical model of the illustrated CNCAP is developed. The model for each CNT cathode and its four nearest neighbor anodes is shown in FIG. 8.

Exploiting the parallel structure of the four anodes, the electrical model in FIG. 8 was transformed to a concise, three element (featuring R′, L′, and C^{T}′), serial model (FIG. 9). This facilitated examination of the capacitor structure's behavior and figures of merit in the analysis section.

$$\begin{matrix}{R}^{′} = \frac{R}{2} + {( \frac{4}{R / 2} )}^{- 1} = \frac{5 R}{8} & ( 15 ) \\ {L}^{′} = \frac{L}{2} + {( \frac{4}{L / 2} )}^{- 1} = \frac{5 L}{8} & ( 16 ) \\ {C}_{T}^{′} = 4 {C}_{T} & ( 17 )\end{matrix}$$

4. Analysis of Cncap

The performance of the illustrated CNCAP is next compared with MIM capacitors. The resistance (R′) and inductance (L′) of the CNCAP constructed of N CNTs of length l was calculated. (This results in a capacitor with N/2 cathodes and N/2 anodes). The results are shown in FIG. 10 for an applied bias of 1V.

The quality factor (Q) of a series three element capacitor model is given by [13]:

$$Q = \frac{1}{2 π fRC} \qquad ( 18 )$$

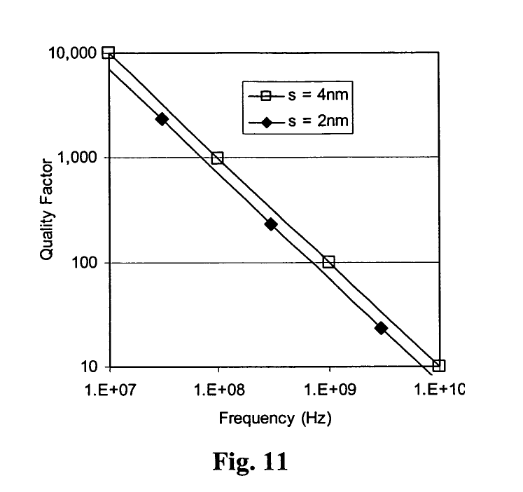

Q of the illustrated CNCAP is shown in FIG. 11.

Note, Q is not a function of the number of CNTs in the CNCAP. As the number of CNTs is increased, the series resistance decreases linearly as the capacitance increases linearly.

The capacitance per unit area of the CNCAP (varying the number of CNT layers) is compared to the projected 2018 requirement for MIM capacitors [2]. Table 1 shows the illustrated CNCAP capacitance per unit area as the number of CNT layers is increased. Note, the CNCAP capacitance per unit area would even be higher for dielectric materials with an improved permittivity. In addition, the CNCAP's capacitance per unit area can be increased or decreased by changing the number of layers of interleaved CNTs.

TABLE 1
Comparison of capacitance per unit area.

| Capacitor | | fF/μm² | | |
|---|---|---|---|---|
| Technology | 2018 ITRS | 32 Layers | 64 Layers | 128 Layers |
| CNT, s = 2 nm | — | 434 | 868 | 1740 |
| CNT, s = 3 nm | — | 265 | 529 | 1060 |
| CNT, s = 4 nm | — | 185 | 369 | 738 |
| MIM | 10 | — | — | — |

Finally, it is noted that the Q requirement for future MIMs is in excess of 100 at 1 GHz [2]. The illustrated CNCAP is capable of exceeding this quality factor for nanotube separations of 4 nm or greater as shown in FIG. 11.

5. CONCLUSIONS

A three-dimensional capacitor structure composed of metallic, single wall carbon nanotubes is provided. The structure can exhibit more than 1 pF/μm² of capacitance per unit area, with an acceptable quality factor in excess of 100 at 1 GHz. Both the capacitance per unit area and the quality factor exceed the 2018 International Technology Roadmap for Semiconductors's roadmap projections. The three-dimensional carbon nanotube capacitor is suitable for integration in future technology nodes (featuring directional carbon nanotube growth and quality metal-to-nanotube contacts). It can be implemented in the upper layers of traditional silicon wafer processing as an add-on module for improved performance in decoupling, analog, and radio frequency signal processing applications.

Although the invention has been described in detail with reference to certain preferred embodiments, variations and modifications exist within the scope and spirit of the present invention as described and defined in the following claims.

What is claimed is:

1. A method of forming a capacitor comprising:
providing an anode and a cathode;
providing an array of carbon nanotubes (CNTS) generally arranged in a plurality of rows and columns;
selectively connecting the CNTs in the array to the cathode and the anode; and
providing a dielectric material between the CNTs.

2. The method of claim 1, wherein the array includes staggered layers of interleaved CNTs which are alternately connected to the anode and the cathode so that each CNT in the array is surrounded by four CNTs connected to an opposing electrode

3. The method of claim 1, wherein each CNT connected to the anode is surrounded by four adjacent CNTs connected to the cathode.

4. The method of claim 1, wherein each CNT connected to the cathode is surrounded by four adjacent CNTs connected to the anode.

5. The method of claim 1, wherein the capacitor has a capacitance/area of greater than 10 fF/μm².

6. The method of claim 1, wherein the capacitor has a capacitance/area of greater than 1 pF/μm².

7. The method of claim 1, wherein the capacitor has a quality factor greater than 100 at 1 GHz.

8. The method of claim 1, further comprising using the capacitor as a replacement for metal-insulator-metal (MIM) capacitor.

9. The method of claim 1, further comprising using the capacitor as a supply voltage variation decoupling circuit.

10. The method of claim 1, further comprising using the capacitor as an add-on module in a top layer of a silicon wafer manufacturing process.

11. The method of claim 1, wherein the CNTs are formed with a single wall.

12. A high density capacitor comprising:
an anode;
a cathode;
an array of carbon nanotubes (CNTs) generally arranged in a plurality of rows and columns, the CNTs being selectively coupled to the cathode and the anode; and
a dielectric material located between the CNTs.

13. The apparatus of claim 12, wherein the array includes staggered layers of interleaved CNTs which are alternately connected to the anode and the cathode.

14. The apparatus of claim 12, wherein each CNT that is connected to the anode is surrounded by four adjacent CNTs connected to the cathode.

15. The apparatus of claim 12, wherein each CNT that is connected to the cathode is surrounded by four adjacent CNTs connected to the anode.

16. The apparatus of claim 12, wherein the capacitor has a capacitance/area of greater than 10 fF/μm².

17. The apparatus of claim 12, wherein the capacitor has a capacitance/area of greater than 1 pF/μm².

18. The apparatus of claim 12, wherein the capacitor has a quality factor greater than 100 at 1 GHz.

19. The apparatus of claim 12, wherein the capacitor is a replacement for metal-insulator-metal (MIM) capacitor.

20. The apparatus of claim 12, further comprising using the capacitor as a supply voltage variation decoupling circuit.

21. The apparatus of claim 12, further comprising using the capacitor as an add-on module in a top layer of a silicon wafer manufacturing process.

22. The apparatus of claim 12, wherein the CNTs are formed with a single wall.
